(19) United States
(12) Patent Application Publication
(10) Pub. No.: US 2005/0248130 A1
(43) Pub. Date: Nov. 10, 2005

(54) Lightweight golf carrier

(76) Inventor: Pierre Beaumier, Sudbury (CA)

Correspondence Address: MIKE GAUTHIER, UNIT C, 959 ELISABELLA STREET, SUDBURY, ON, P3A 5K1, CA

(21) Appl. No.: 10/842,035

(22) Filed: May 7, 2004

(51) Int. Cl. B62B 1/00

(52) U.S. Cl. 280/652

(57) ABSTRACT

A folding golf cart having multi-organizational feature comprising: a body portion having a generally planar vertical member on which an upper plate is firmly attached frontwardly therefrom, a lower plate member also firmly attached frontwardly therefrom, a handle receiving member, whose multiple trough-bores align generally with similar through-bore within the upper plate member. Both upper and lower plate members are perpendicularly reinforced with each a pair of generally triangular supports fixedly attached to said upper and lower plate members respectively. A pair of vertical struts is adapted to firmly join the frontmost edges of the upper and lower plate members. Said struts also provide attaching means for accessory holders and a utility storage compartment. A ball rack is provided and fixedly attached to the underside of the upper plate member, and a scorecard clip is also attached to the upper surface of said upper plate member. Accessory holders include an umbrella and ball retriever holder. The cart is implemented with a retracting wheel system that automatically extends when the cart handle is raised from its collapsed position.

### FIELD OF THE INVENTION

The present invention relates to a folding golf cart having multi-organizational features comprising: a body portion having a generally planar vertical member on which an upper plate is firmly attached frontwardly therefrom, a lower plate member also firmly attached frontwardly therefrom, a handle receiving member, whose multiple trough-bores align generally with similar through-bore within the upper plate member. Both upper and lower plate members are perpendicularly reinforced with each a pair of generally triangular supports fixedly attached to said upper and lower plate members respectively. A pair of vertical struts is adapted to firmly join the frontmost edges of the upper and lower plate members. Said struts also provide attaching means for accessory holders and a utility storage compartment. A ball rack is provided and fixedly attached to the underside of the upper plate member, and a scorecard clip is also attached to the upper surface of said upper plate member. Accessory holders include an umbrella and ball retriever holder. The cart is implemented with a retracting wheel system that automatically extends when the cart handle is raised from its collapsed position.

### BACKGROUND OF THE INVENTION

Since golf's beginning, many golf bags and carts have seen the course, but usually as separate items. Additionally, such bags are generally opened only at the top and are adapted with a plurality of integral pouches for storing of balls, tees and the like. Furthermore, the interior of such bags proves difficult to keep clean and one cannot reach the bottom of these bags in most cases.

Accordingly, it is desirable for golfers to have access to all areas of their cart/bag while enabling easy organizational feature of accessories and the like. Furthermore, golfers desire the ability to easily clean their golf bag.

Furthermore, the assembly in the like of the present invention helps reduce the whole weight of the unit therefore preventing undesired effort in a sport of enjoyment.

While many prior art inventions have succeeded in providing means for golfers to lug their golf need around a course, none combine the ease of cleaning and multi-organizational features of the present invention.

### SUMMARY OF THE INVENTION

It is thus the object of the present invention to provide golfers with a lightweight cart/bag enabling access to all areas of their cart/bag while enabling easy organizational features of accessories and the like, with the ability to easily clean their golf bag.

In one aspect of the invention, the folding golf cart of the present invention may be fabricated from any suitable lightweight material.

In another aspect of the invention, the folding golf cart may vary in size and form to adapt to any comfortable body size.

Accordingly, the folding golf cart of the present invention provides golfers with a lightweight cart/bag enabling access to all areas of their cart/bag while enabling easy organizational features of accessories and the like, with the ability to easily clean their golf bag.

The utility of this accessory device is intended for golf bags and carts or a combination thereof.

### BRIEF DESCRIPTION OF THE DRAWINGS

These and other advantages of the invention will become apparent upon reading the following detailed description and upon referring to the drawings in which:—

FIG. 1 is a front perspective view from above of the folding golf cart of the present invention.

FIG. 2 is a right side elevation view of the folding golf cart of the present invention.

FIG. 3 is top plan view of the folding golf cart of the present invention

FIG. 4 is a perspective view of the ball rack of the folding golf cart of the present invention.

FIG. 5 is a rear perspective view from above of the folding golf cart of the present invention.

While the invention will be described in conjunction with illustrated embodiments, it will be understood that it is not intended to limit the invention to such embodiments. On the contrary, it is intended to cover all alternatives, modifications and equivalents as may be included within the spirit and scope of the invention as defined by the appended claims.

### DETAILED DESCRIPTION OF THE PREFERRED EMBODIMENT

In the following description, similar features in the drawings have been given similar reference numerals.

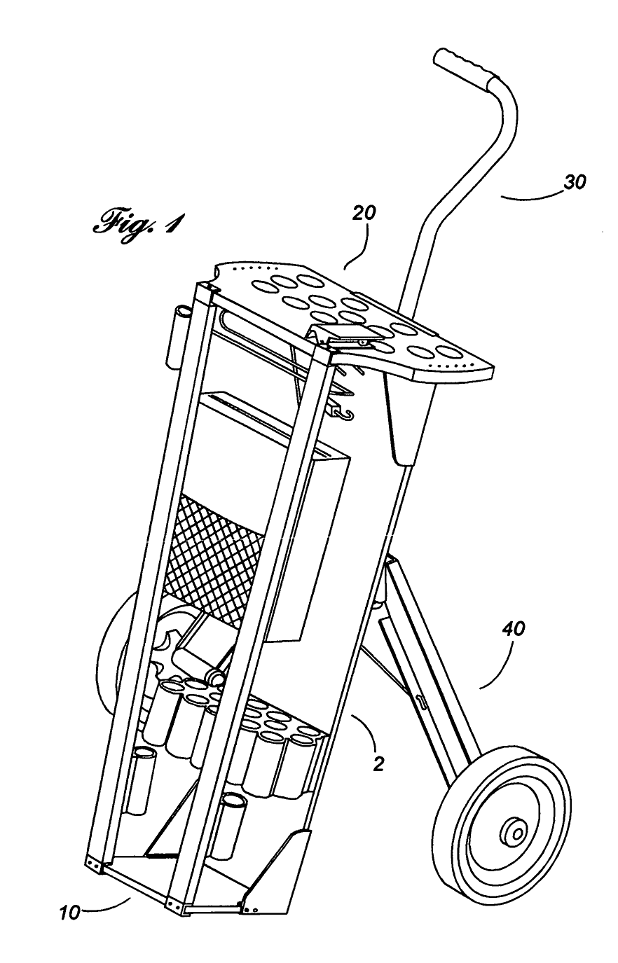

Turning to FIG. 1, a front perspective view from above of the folding golf cart of the present invention, which illustrates the arrangement of the various components forming part of said invention comprising generally: a body plate portion 2, a base portion 10, a top portion 20, a handle portion 30, and a wheel assembly portion 40 wherein the base portion 2 provides fixation to generally all other components of the present invention.

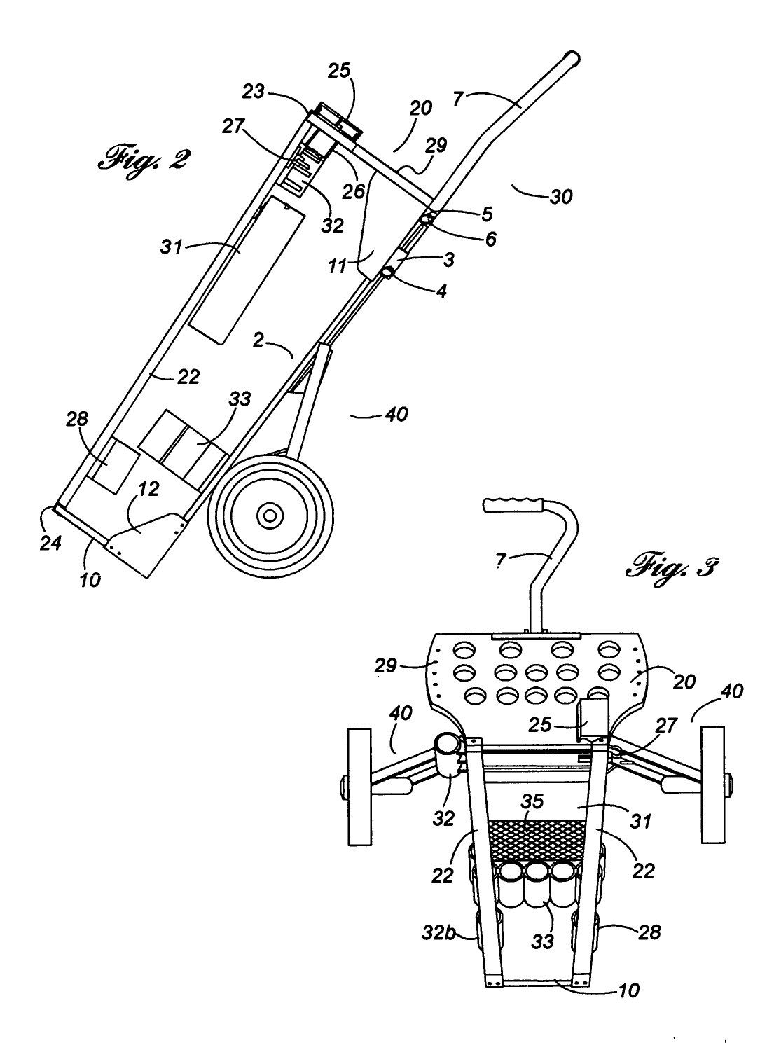

Turning now to FIG. 2, a right side elevation view of the present invention wherein, the arrangement of the body plate portion 2, the base portion 10, the top portion 20, the handle portion 30, and the wheel assembly portion 40 can be further observed. A pair of rearwardly protruding brackets 3 through which each is perforated horizontally to accept a handle axle 4. Above these brackets 3 are a pair of secondary brackets 5 also perforated horizontally to accept a handle retainer 6. The handle 7 is adapted with three perforations near the lower portion thereof wherein the lower perforation is pivotal, the upper is for retention and the central perforation is to pivotally engage a wire 8 formed to mechanically and systematically link the handle 7 with the wheel assembly 40. For structural integrity, reinforcement members 11 and 12 are securedly attached between the upper side edges of the base portion 2 and the rear side edges of the top portion 20, and between the lower side edges of the base portion 2 and the rear side edges of the bottom portion 10. A pair of vertical strut members 22 are provided having a generally rectangular tubular profile and molded upper and lower end adapters 23 and 24 fixedly attached at each end of the strut members 22 and fitting to engage at the front edge of both top and bottom portions 20 and 10 respectively. Accessories included in the present invention include the following:
Golf tee holders 29 comprising: a plurality of perforations near and though both upper side edges of the top portion 20,
A scorecard clip 25 comprising: a fixed clip base having axle members adapted to rotationally engage with perforations through downwardly protruding members integrally attached to clip portion. A spring provides constant downward pressure from the clip's front edge to the top portion 20,
A ball rack 26 formed of high tensile wire material is attached to the underside of the top portion 20 by means of a plurality of perforated brackets integral with said ball rack 26. The wire ball rack 26 is formed so as to allow frictional engagement of a plurality of golf balls while allowing removal thereof with little effort.
An umbrella clip 27 and holder 28 comprising: a lower cylindrical body mounted at the inner lower surface of a strut 22, and a spring-retracted hook within the umbrella clip 27. An umbrella would therefore be inserted tip first into the holder 28, then retained within said clip 27 at and near the top of same strut 22.
A storage compartment 31 is suspendedly mounted to a mid section of the struts 22 wherein said compartment is removable and zippered so as to allow convenient egress thereto. A mesh sleeve 35 is attached to the storage compartment at its sides and bottom edges and provides additional easy to see storage of small, frequently used items.
A ball-retriever holder 32 comprising an upper cylindrical body mounted at the inner upper surface of a strut 22, and a lower cylindrical body mounted at the inner lower surface of same strut 22 opposite to a similar umbrella holder cylindrical body.
A club holding and organizing portion comprises: a top plate 20 having an array of perforations through which golf clubs traverse in the generally downward direction toward a corresponding club holder 33 mounted near the bottom portion of the base 2.

Turning now to FIG. 3, illustrating a top plan view of the folding golf cart of the present invention further depicting the various accessories therewith. The following can now be more clearly seen in this alternative illustration; the top plate 20, the scorecard clip 25, the handle 7, golf tee holders 29, umbrella clip 27, umbrella holder 28, club holder 33, ball retriever holder 32 and 32b, storage compartment 31, struts 22, bottom plate 10 and wheel assemblies 40.

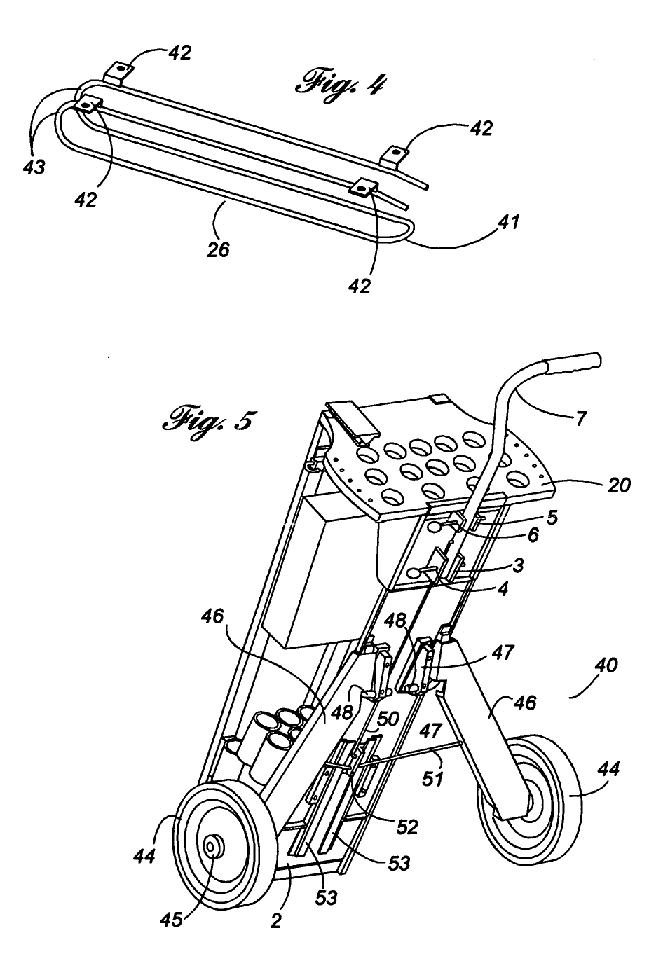

FIG. 4, a perspective view of the ball rack 26 having a unibody wire form semi-radially joined on a slightly raised horizontal plane at its lower central portion 41, and two upper wire portions adjacent to the lower pair also radially formed at a rear portion 43 from each of the lower wire portions. A plurality of perforated brackets 42 is securedly attached to the upper most wire surface, providing attachment means of the ball rack to a planar under surface such as the top plate in this case.

In FIG. 5, the wheel assembly 40 is better depicted comprising: two wheels 44 each having an axle member 45, wheel struts 46, strut mounts 47 and strut axles 48. A guide wire 50 is rotationally engaged within a perforation in the handle 7 member and oppositely engaged within a perforation through a glider 52, which travels longitudinally within a similarly mating channel formed with the presence of two glider tracks 53 fixedly attached to the rear lower portion of the base 2.

Therefore, pivotally lowering the handle 7, the link wire 50 moves the glider 52 downwardly, which in turn pulls the strut wire's 51 central portion down as well, collapsing the wheel assembly 40 into a more compact package. Moreover, a golfer, with the present invention, can have easy access to its golf accessories and the ability to easily clean the cart.

THE EMBODIMENTS OF THE INVENTION IN WHICH AN EXCLUSIVE PROPERTY OR PRIVILEGE IS CLAIMED ARE DEFINED AS FOLLOWS:—

1. A folding golf cart comprising:
a) a body portion having a generally planar vertical member
b) an upper plate firmly attached frontwardly therefrom,
c) a lower plate member also firmly attached frontwardly therefrom,
d) a handle receiving member whose multiple trough-bores align generally with similar through-bores within the handle member,
e) a pair of generally triangular supports fixedly attached to said upper and lower plate members respectively,
f) a pair of vertical struts adapted to firmly join the frontmost edges of the upper and lower plate members,
g) a ball rack fixedly attached to the underside of the upper plate member,
h) a scorecard clip also attached to the upper surface of said upper plate member,
i) an accessory umbrella and ball retriever holders, and
j) a retracting wheel system that automatically extends when the cart handle is raised from its collapsed position.

2. The folding golf cart of claim 1 wherein said body portion is formed so as to allow the mating of varied components of the present invention.

3. The folding golf cart of claim 1 wherein the upper plate further comprises a plurality of perforations adapted to frictionally and gravitationally engage golf tees.

4. The folding golf cart of claim 1 wherein the lower plate is fabricated from a semi resilient material so as to absorb some shock exerted by a club handle when inserted trough its holder.

5. The folding golf cart of claim 1 wherein the pair of generally triangular supports is milled and formed so as to engage generally frictionally with their respective upper and lower plate members.

6. The folding golf cart of claim 1 wherein the pair of vertical struts is hollow and rectangular so as to accept end brackets.

7. The folding golf cart of claims 1 and 6 wherein the end brackets are formed so as to engage within the vertical struts, and the frontmost edges of the upper and lower plate members respectively.

8. The folding golf cart of claim 1 wherein the ball rack, mounted beneath the upper plate member, is fabricated of a generally resilient material and is adapted to frictionally hold golf balls within the ball rack.

9. The folding golf cart of claim 1 wherein the scorecard clip, is rotationally engaged onto a pivot base, which is fixedly attached to the upper surface of the upper plate member.

10. The folding golf cart of claims 1 and 9 wherein the scorecard clip, is adapted with a spring applying a small pressure from the clip to the upper plate member.

11. The folding golf cart of claim 1 wherein the retracting wheel system is adapted with a wire guide attached in a V formation and connected such that when the carry handle is raised, the wheels erect in rolling position, and when the carry handle is lowered, the wheel system retracts in a collapsed position.

12. The folding golf cart of claims 1 through 11 wherein the utility thereof is adapted to golf carts and golf bags, singularly or combined.
